(19) United States
(12) Patent Application Publication
(10) Pub. No.: US 2007/0207243 A1
(43) Pub. Date: Sep. 6, 2007

(54) Preservation of Jerusalem artichoke tubers and roots

(76) Inventor: Fritz B. Harris, Gilroy, CA (US)

Correspondence Address: Fritz B. Harris, 860 Chesapeake Place, Gilroy, CA, 95020, US

(21) Appl. No.: 11/369,232

(22) Filed: Mar. 6, 2006

(51) Int. Cl. A23L 2/02

(52) U.S. Cl. 426/489

(57) ABSTRACT

The simple version of the process of storage of Jerusalem Artichoke rubbers, or roots, is as follows. The Jerusalem Artichoke plant is harvested by cutting down the stalk and removing the stalks from over the tubers or roots. Then, the tubers are dug out of the ground, as is done in potato harvesting. The tubers are then washed thoroughly to remove all soil and other contaminants. After washing and draining off the water, the tubers are then passed through a grinder to produce ⅛″ to 3/16″ size particles and the juices. The ground tuber material and juices are collected in tanks. A mineral acid, sulfuric, or other is added to the mix of tubers and juices to produce a pH of less than 2.0. This pH level of less than 2.0 inhibits fermentation and rotting. The mixture of tuber particles and juices with the acid are thoroughly agitated and then collected in closed storage tanks to be stored in until future usage. The stored mixture will then stay in a state free of spoilage or rotting until it is needed for future processing into ethanol. The storage is maintained in closed or sealed tanks.

### BACKGROUND OF INVENTION

The importance of ethanol as a fuel and as a smog reducer as a gasoline additive is now well recognized. The primary renewable source of ethanol is corn. But due to corn's importance as a food, other sources have been sought.

The most prolific new source has been Jerusalem Artichoke. It produces more sugar for providing ethanol than any other renewable source now available. A major problem with processing the Jerusalem Artichoke tuber or root is the high cost of having to store the tubers or roots in refrigerated storage to keep them from decomposing and rotting between harvesting and processing into ethanol. This storage cost makes it less practical as a source in place of corn.

In order to be able to make use of this superior source of ethanol, a less costly storage system had to be discovered. This invention was developed to provide a system of storage of the valuable tuber or root's sugar between the digging process and the alcohol processing stage. It was discovered that by the addition of acid, as described herein, to the tuber sugar juices, that the liquid mass can be stored without decomposition or rotting in the storage tanks where it is held for further processing.

In U.S. Pat. No. 4,400,469, the process for converting Jerusalem Artichoke stalks into ethanol is described. At the time of issuance of the above-mentioned patent, no method was detailed for the usage of the Jerusalem Artichoke tuber for distillation into ethanol.

No part of the text has been added to or deleted.

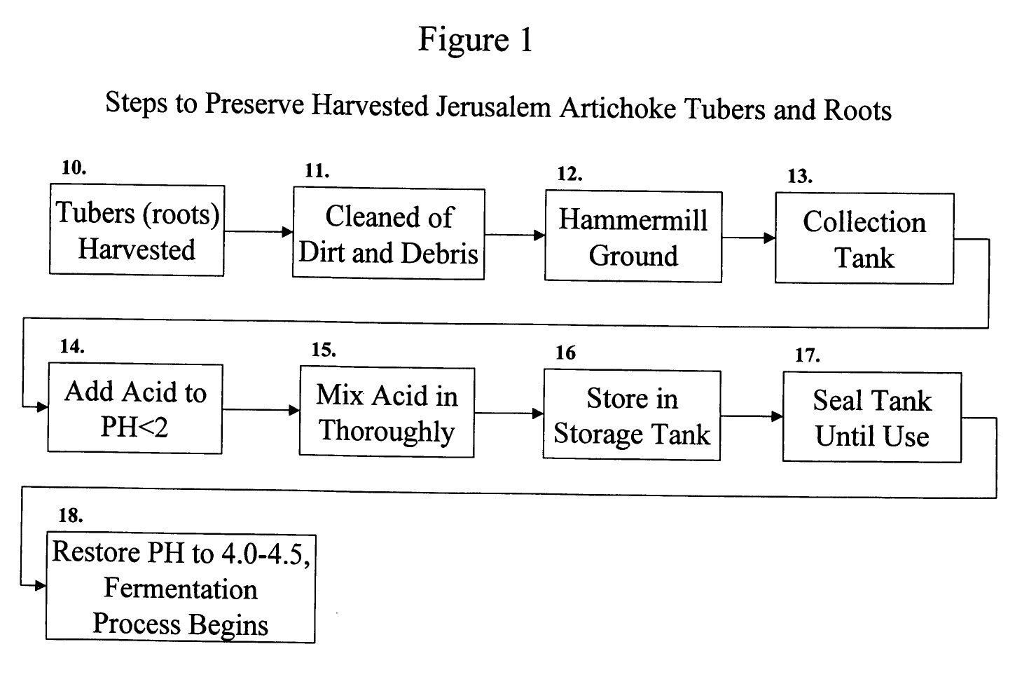

### BRIEF DESCRIPTION OF THE DRAWINGS—FIG. 1

STEP (0010) SEPARATE TUBER (ROOTS) AS DUG FROM EARTH

STEP (0011) SEPARATE EARTH AND DEBRI FROM TUBER (ROOTS) BY WASHING

STEP (0012) GRIND TUBERS (ROOTS) TO LIQUID-LIKE STATE

STEP (0013) COLLECTION OF LIQUID INTO TANK

STEP (0014) ADDING OF ACID TO TUBER LIQUID

STEP (0015) MIXING OF ACID THROUGHOUT LIQUID

STEP (0016) HOLDING MIX IN STORAGE TANK

STEP (0017) TEMPORARY SEALING TANK UNTIL READY TO FERMENT

STEP (0018) CARRY OUT FERMENTATION PROCESS

### DETAIL DESCRIPTION OF THE EXEMPLARY EMBODIMENT OF THE INVENTION

Referring now more particularly to FIG. 1, the detailed description of the process of preserving the harvested Jerusalem Artichoke tubers, or roots, and sugar juices for future processing or other use follows.

The stalks are cut off at the surface of the ground, which is the level just above the tubers. The tubers are then (10) removed from the soil in the same manner used in harvesting potatoes. Care is taken to not damage the tubers or cut them up. The tubers are in a pod-type growth and have to be separated in individual units. (11) The tubers are then passed along a separating belt where the soil is loosened and removed. As soon as the bulk of the soil is removed, the tubers are then thoroughly washed to remove all of the dirt and other contaminants. The clean tubers are wet and must have the surface water blown off before further processing. (12) At this point, the tubers are passed through a grinder to produce ⅛″ to 3/16″ size particles and juices. (13) The ground tuber particles and juices are collected in mixing tanks where a (14) mineral acid, sulfuric, or other is added to the tuber particles and juices to produce a pH of less than 2.0. The mixture of tuber particles and juices with the acid are (15) thoroughly agitated to equally distribute the acid then (16) collected in storage tanks to be stored in until future usage. The stored mixture will then stay in a state free of spoilage or rotting until such time as it is needed for future processing into ethanol or other products. The storage is (17) maintained in closed or sealed tanks. The combination of tubers, juices, and acid is beneficial for the later processes that follow. (18) When ready to use, the pH of the stored mix is adjusted to 4.0-4.5 with hydroxide. This adjustment prepares the mix for the second step in the process of fermentation into ethanol.

What is claimed is:

1. The developed process allows for the storage of harvested tubers, including but not limited to, Jerusalem Artichoke, in a state free of spoilage or rotting while inhibiting fermentation for an indefinite period of time.

2. The addition of mineral acid, such as but not limited to sulfuric acid, lowers the mass of ground tubers to a pH of less than 2, thereby inhibiting fermentation or rotting for an indefinite period of time.

3. The grinding of the tubers allows for equal access to the entire stored mass of tubers by the mineral acid, thereby altering the pH of the entire mass to less than 2 to prevent spoilage or rotting and inhibit fermentation.

4. The thorough mixing of the mineral acid into the ground mass of tubers prevents any area of the mass from exceeding a pH of 2, thereby inhibiting spot fermentation or rotting.

5. The storage of the material in a closed container prevents outside contamination or the atmosphere from raising the pH of the mass above a pH of 2, thereby continuing the inhibition of fermentation and the prevention of spoilage or rotting of the storage.
